(19) United States
(12) Patent Application Publication
(10) Pub. No.: US 2010/0149168 A1
(43) Pub. Date: Jun. 17, 2010

(54) METHOD OF ADDRESSING A LIQUID CRYSTAL MATRIX SCREEN AND DEVICE APPLYING THIS METHOD

(76) Inventor: Patrick Thomas, Issy Les Moulineaux (FR)

Correspondence Address: GREER, BURNS & CRAIN, 300 S WACKER DR, 25TH FLOOR, CHICAGO, IL, 60606, US

(21) Appl. No.: 12/600,814

(22) PCT Filed: Apr. 15, 2008
(86) PCT No.: PCT/FR08/00543

§ 371 Date: Nov. 18, 2009

(30) Foreign Application Priority Data
May 18, 2007 (FR) 0703554

(51) Int. Cl. G09G 3/36; G06F 3/038

(52) U.S. Cl. 345/213; 345/100

(57) ABSTRACT

A method is provided for addressing a bistable nematic liquid crystal matrix screen having two stable states in the absence of an applied electric field. The switching of each pixel from a stable state to another stable state, is controlled by a switching electrical voltage pulse obtained by the application of at least one row-addressing signal applied to a row-addressing electrode and the application of at least one column-addressing signal applied to a column-addressing electrode. The features of the row-addressing signals and/or the features of the column-addressing signals are a function of the position of the pixel in the matrix screen.

The invention relates to a method for addressing a liquid crystal display screen and a display device applying this method.

The field of the invention is that of liquid crystal displays.

More particularly, the present invention relates to bistable nematic liquid crystal displays. It relates in particular to bistable nematic liquid crystal displays where two stable textures differ by a twist of approximately 180°.

The purpose of the present invention is to improve the performance of bistable display devices. In particular, the purpose of the invention is, by using novel means, to improve switching between states of the pixels of the display in such a way as to render the desired switching of the pixels homogeneous over the whole of the display.

### STATE OF THE ART

The most widely-used liquid crystal displays employ a nematic-type liquid crystal. They are constituted by a layer of liquid crystal placed between two plates. Each plate comprises a substrate, frequently made of glass, on which a conductive electrode then a so-called anchoring layer, also known as an alignment layer, have been deposited. The anchoring layer exerts a return torque on the liquid crystal molecules in the vicinity, which tends to orient them parallel to a direction termed the easy axis. The anchoring layers are often produced by a deposit of brushed polymer for creating the direction of the easy axis. The latter is frequently very close to the direction of brushing.

The thickness of the cell thus constituted is rendered constant by distributing between the plates, balls the diameter of which is equal to the desired thickness (typically 1 to 6 μm).

The majority of liquid crystal-based devices proposed and produced to date are monostable. In the absence of an electric field, the liquid crystal is oriented according to a single texture. It corresponds to an absolute minimum of the elastic energy of the liquid crystal in the cell, taking account of the anchorings on the two plates. Under an electric field, this texture is continuously deformed and its optical properties vary as a function of the applied voltage. Close to the plates, the anchoring layers called “strong anchoring layers” maintain the direction of the molecules. Their direction does not vary greatly. When the electric field is turned off, the nematic is returned by the anchorings on the two plates. It returns according to the stable texture. The device is monostable. A person skilled in the art will recognise the mode of operation of the most widespread nematic displays: twisted nematic (TN), super-twisted nematic (STN), electrically controlled birefringence (ECB), vertically aligned nematic (VAN), etc. At the addressing level, these displays can be addressed directly (very low resolution), in multiplex mode (medium resolution) or in active mode (high resolution).

State of the Art of Bistable Displays:

A new generation of nematic displays, called “bistable”, has appeared in the last few years: they operate by switching between two states which are stable in the absence of an electric field. The external electric field is only applied for the time necessary to make the texture of the liquid crystal switch from one state to the other. In the absence of a controlling electrical signal, the display remains in the obtained state. Due to its operating principle, this type of display has a power consumption proportional to the number of changes of images. Thus, when the frequency of these changes reduces, the power necessary for the operation of the display tends towards zero.

Operating Principle

The bistable display that we will designate in the description hereafter under the trade name BINEM® ([I] to [5]) is shown diagrammatically in FIG. 1.

It uses two textures, one uniform or weakly twisted U (illustrated on the left of FIG. 1) in which the molecules are approximately parallel to each other, and the other T (illustrated on the right of FIG. 1) which differs from the first by a twist of approximately +/−180°, in absolute value between 150° and 180°. The liquid crystal layer 30 is placed between two plates 20 and 10, called master plate and slave plate. The master plate 20 comprises a substrate 21, an electrode 22 and an anchoring layer 24 producing a high azimuthal and zenithal anchoring of the liquid crystal. The slave plate 10 comprises a substrate 11, an electrode 12 and an anchoring layer 14 producing a low zenithal anchoring and a medium or high azimuthal anchoring of the liquid crystal. The electrodes 12 and 22, usually transparent, are typically constituted by a material called ITO and are deposited on the substrates 11 and 21. They make it possible to apply an electric field perpendicular to the plates 10 and 20.

The adjunction of polarizers on each of the substrates 11 and 21 typically outside the cell makes it possible to associate each texture with an optical state, for example dark for texture U and light for texture T or vice-versa, as a function of the angles of the two polarizers with respect to the anchoring directions.

Depending on the type of rear polarizer, i.e. situated on the other side of the liquid crystal layer with respect to the viewer of the display, it is possible to obtain various optical modes, transmissive, transflective or transmissive ([10]; [11]).

The nematic is chiralized with a spontaneous pitch po, chosen to be close to four times the thickness d of the cell, in order to equalize the energies of the two textures mentioned previously. The ratio between the thickness d of the cell and the spontaneous pitch po, i.e. d/po, is therefore approximately equal to 0.25+/−0.1. In the absence of a field, the states T and U are the minimum energy states: the cell is bistable.

Under a high electric field an almost homeotropic texture, called H and illustrated in the centre of FIG. 1, is obtained. In the vicinity of the surface of the slave plate 10, the molecules are perpendicular thereto, the anchoring is said to be “broken”. The electrical voltage corresponding to breaking the anchoring on the slave plate 10 is called the breaking voltage Vbreak. When the electric field is cut, the cell changes towards one or the other of the bistable textures U and T (see FIG. 1). When the control signals used induce a strong flow of the liquid crystal near the master plate 20, the hydrodynamic coupling 26 between the master plate 20 and the slave plate 10 creates a hydrodynamic flow (or flux) close to the slave plate, sufficient to induce the texture T. In the opposite case, the texture U is obtained by elastic coupling 28 between the two plates 10 and 20, helped by the possible tilt of the weak anchoring.

Hereafter, by “switching” of a BiNem® screen element is meant the change of the liquid crystal molecules from an initial stable texture (U or T or a coexistence of these two textures) to a final stable texture (U or T or a coexistence of these textures). The signal applied to the pixel is in a standard fashion constituted by several plateaux, the transitions from one plateau to the other being called edges. Each plateau is preceded by a leading edge constituted by the transition between the previous plateau and said plateau and followed by a trailing edge constituted by the transition between said plateau and the following plateau. Switching off the electric field corresponds to one or more trailing edges of the applied signal (reduction of the electrical voltage in absolute value). The signal applied to the pixel VP (FIG. 2) is in a standard fashion a two-plateau signal, but can also be a multi-plateau [6] or single-plateau signal. The name active trailing edge will be given to the trailing edge that makes it possible, as a function of its characteristics, to choose the final state in terms of texture. If the active trailing edge exceeds a certain absolute value, and operates over a sufficiently short time (<tmax), the voltage “jump” is sufficient for texture T to be obtained. If the jump is not sufficient, or if the transition time is too long (>tmax), the hydrodynamic flow is insufficient, texture T becomes impossible, and texture U is necessarily obtained. An example of a two-plateau pixel signal (V1P, V2P) is given in FIG. 2. In this figure, it can be seen that at a constant V1P, textures U or T are obtained as a function of the V2P value. For the values of V2P in the p12 range, the hydrodynamic flux is insufficient, texture U is obtained. When V2P is in the p11 range, the active trailing edge making it possible to obtain a jump generating a sufficient hydrodynamic flux to obtain texture T is the V2P-to-0 transition, i.e. V2P.1, while when V2P is in p13, the active trailing edge making it possible to obtain texture T is the V1P-to-V2P transition, i.e. V2P.3.

It is also possible to obtain grey levels in a pixel by controlling the intensity of the hydrodynamic flow via signal variation at the pixel terminals. For a given value of the pixel signal, within a single pixel, a fraction of its surface in texture T and the other fraction in texture U, is obtained. Another value of pixel signal and therefore of this hydrodynamic flow, corresponds to a different ratio between the surfaces occupied by the two textures U and T. Grey levels are thus obtained [9].

The fact that the switching is directly linked to the intensity of the flow close to one of the plates 10 and 20 (FIG. 1), and therefore to the amplitude of the active trailing edge and the drop time tmax, as defined previously, is a specific characteristic of BiNem® displays, standard displays do not switch according to this principle.

The 3 addressing modes developed for standard liquid crystals (direct, multiplex, active) can be used for the BiNem® display. The most common addressing mode of the Binem® display is passive multiplexed addressing, but an active addressing using transistors in thin layers is also possible [7]. In the active and passive multiplexed modes, the Binem® display is a matrix screen made of N×M screen elements called pixels, N being the number of rows and M the number of columns, and the addressing is carried out row by row.

In the passive multiplexed mode, each pixel is constituted by the intersection of a row conductive band 52 and a column conductive band 50 (see FIG. 3). These perpendicular bands are deposited respectively on the master plates 20 and slave plates 10. The area situated between two adjacent conductive bands carried by a single substrate 11 or 21 (FIG. 1) is called the interpixel space. The area constituted by the pixels as a whole is called the matrix area. Customarily in the state of the art, the matrix area corresponds to the display area, the area on which is displayed the content of the image that it is desired to be seen. Outside the matrix area, the conductive bands 50, 52 mentioned previously are transformed into tracks providing the connection to the control circuits generating the addressing signal. These control circuits can be situated on the substrate or offset. In a standard fashion, but non-limitatively, the displays are addressed using control components or circuits that we will call “drivers”, situated for example on flexible connection elements soldered to the screen. The drivers, constituted principally by analogue gates controlled by shift registers, enable the link to be made between the control electronics and the tracks.

To display the pixel of coordinates (n, m) a row addressing signal VLn is applied on row n and a column addressing signal VCm is applied on column m. Generally, the conductive electrodes are produced with a transparent conductive material called ITO (indium tin mixed oxide). But when the display is reflective, the electrodes situated on the opposite side to the observer can be produced with an opaque conductive material, for example aluminium.

One of the important differences to note between the passive mode and the active mode is that in the passive multiplexed mode, the electric voltage is applied via strips of orthogonal electrodes constituting the rows and the columns, the intersections of which constitute the pixels, while during active addressing, the electric voltage is applied via fine wires connected to the transistor associated with each pixel, the transistor playing a switching role becoming on-state during activation of the row.

Control of a Binem® Display in Multiplexed Mode:

When the structure of the display is matrix-type as described previously, addressing is carried out row by row. When it is desired to write to a given row n, an electrical signal is applied to this row, which is then said to be “activated”. We will call this row addressing signal, the VLn activation signal. In the case of a standard passive multiplexing, the signal VLn is identical for all the rows, and we will call it VL.

For BiNem, two phases are distinguished during activation: the first phase consists essentially of obtaining an anchoring breaking, that is to say the homeotropic texture on the row in question, by applying for example a voltage V1L>Vbreak to the row addressing signal for a duration T1, which constitutes a first plateau of VL. Typically in the current state of the art for BiNem, V1L is comprised between 6V and 30V over the temperature range 0°-50°. During the second phase, a signal V2L is applied to the row for example V2L £ V1L for a duration T2, which constitutes a second and last plateau of VL. Typically in the current state of the art for BiNem, V2L is comprised between 2V and 12V over the temperature range 0°-50°. The row addressing signal is in this example a two-plateau signal, but it can also be a single-plateau or multi-plateau signal. Electrical signals known as <<data>> called VC are applied simultaneously on all the columns. According to a standard variant, the trailing edge of the signal “data” VC is synchronised with the trailing edge of the second plateau of the row activation signal V2L [1]. Depending to the value of the voltage VCm (in this case by way of example the signal VCm is a square of amplitude±Vcol, but the signal VC can also be multi-plateau) and/or the form and/or the duration tc of the signal VCm applied simultaneously to each of the columns, texture U or T is obtained in the pixel corresponding to the intersection of this column and the activated row [6]. Then the following row is activated in turn, the other rows being non-activated and so on, from the first to the last row of the display. The time between the end of activation of a row and the start of activation of the following row is called inter-row time TL. This time is typically but non-limitatively comprised between 10 μs and 10 ms. The value of this time is very important in order to obtain correct switching, and can vary with temperature. We will call this addressing “one-step addressing”. The order of activation of the rows (first n−1, then n, then n+1) defines the direction of sweep 46 (FIG. 3). The addressing time of the display is the time necessary for addressing all its rows, in such a way as to display a new image content.

Document [9] describing the implementation of grey levels provides three variants for obtaining grey levels (FIG. 23 of the document [9]) by modifying the VC parameters. A first variant consists of varying the amplitude of the voltage level of the plateau Vcol (in the case of a column-addressing signal of the square type) applied to the pixel P. A second variant consists of varying the duration tc of the column-addressing signal VC applied to the pixel P. In these two variants the trailing edge of the column-addressing signal is synchronized with the trailing edge of the second and last plateau of the row-addressing signal. A third variant called “phase modulation”, consists of the variation of the desynchronization ΔTc of the column-addressing signal VC with respect to the trailing edge of the second and last plateau of the row-addressing signal. Document [12] recommends a desynchronization of the column-addressing signal with respect to a trailing edge of an intermediate plateau other than the last plateau of the row-addressing signal.

According to a method of use called partial addressing, it is desired to display new content in only one area of the image, the remainder of the image remaining unchanged. In this case, only the rows corresponding to the display area are activated.

According to a preferred known, but non-limitative, control method, prior to the row-by-row addressing, the full addressing of the screen (display of a whole image), or of an area of the screen (partial addressing) is carried out collectively in a given texture, usually T, by simultaneously activating all the rows or a group of rows corresponding to the area to be addressed, with a signal Vpre (see FIG. 4). The rows are then addressed one by one, according to the standard multiplexing method, in order to display the desired image or area. Thus only two types of transitions have to be carried out, the transition T to T on the one hand, and the transition T to U or to a mixture of U and T on the other hand. This “two-step addressing” allows better management of pixel switching, in particular as regards control of the grey level, as in this way the pixels all start from a well-defined state at the beginning of the second step.

By way of example, the principle of multiplexed passive addressing of the Binem® display in two steps is illustrated in FIG. 4. The column-addressing signal applied to the column m is chosen here such that tc=T2. The values VC1 to VC5 are the values of VCm applied on the column m synchronized with the successively activated rows 1 to 5, in order to obtain the desired final texture on the pixel at the intersection of the activated row and the column m. In a mode where it is sought to obtain only either U or T, it is possible to choose for example a voltage VC in square form and different variants are possible:

VC(U)=+Vcol and VC(T)=−Vcol

or:

VC(U)=+Vcol and VC(T)=0,

or vice-versa.

According to a preferred known but non-limitative embodiment of a BiNem display, the brushing direction of the alignment layers is orthogonal to the direction of the rows of the display, this type of display is known as having “orthogonal brushing” (document [9]).

Thus the pixel signal VP is characterized by row parameters (independent of the desired texture) and column parameters (of which some are variable, as a function of the desired texture on the pixels):
row parameters of signal VL: voltage levels and duration of each plateau, for example (V1L, V2L, T1, T2) and inter-row time TL
column parameters of signal VC: voltage levels and duration of each plateau, for example for a single-plateau square signal (Vcol, tc), optionally desynchronization value ΔTc with respect to a trailing edge of a row signal.

According to the state of the art, these parameters are a function of the temperature and the size of the pixels.

In order to obtain controlled switching of a Binem® display while retaining a low row-addressing time (rapid addressing), it is preferable to keep constant the mean squared voltage (Vrms) experienced by a given pixel for the whole addressing time of the display [8]. When Vcol(U)=Vcol(T) in absolute value and tc identical for the two textures, the Vrms is intrinsically constant and independent of the content of the image.

A simple means of implementation, in the case where Vcol (U)≠Vcol (T) in absolute value, is to carry out this compensation row by row, by the column signal. During the activation time of the row in question n, a signal Vcomp is applied on the column in question m, at a moment when this signal will have no influence on the choice of final texture. Then the signal “data”, is applied, synchronised preferably at the end of the signal “activation”. The amplitude of the signal Vcomp, typically a square, is calculated as a function of the value Vc of the column signal “data” in order to obtain a pre-determined constant mean squared voltage Vrms, identical for each pixel [8]. FIG. 5 illustrates an example of a chronogram applying this method. The activation voltage of the row n is bipolar in this example, ??? in order to prevent the effects of electrolysis of the liquid crystal, but only the second part of the signal VL, in this example the positive polarity, constitutes the useful signal for addressing the row in question. Two examples, Vcol1 and Vcol2, of column signals are illustrated, with values (Vc1,tc1) and (Vc2,tc2) each corresponding for example to a determined grey level. It can be seen that the value of Vcomp (duration and/or amplitude) varies as a function of the signal “data” that is applied, in order to obtain in both cases a constant and predetermined mean squared value Vrms.

After a number of experiments, several types of switching defects have become apparent. These defects appear in spatially determined areas of the display.

A high sensitivity of the pixel-switching to the set of parameters described below is noted:
addressing parameters of the VL row-addressing signal:

voltage level of each plateau, duration of these plateaux, and inter-row time TL. For example in the case of a row-addressing signal comprising two plateaux: (V1L, V2L, T1, T2, TL)
addressing parameters of the column signal VC:

voltage level of each plateau, duration of these plateaux, desynchronization value ΔTc of a trailing edge of a plateau of the column-addressing signal with respect to a trailing edge of a plateau of the row-addressing signal, Vcomp value. For example in the case of a column-addressing signal comprising a single plateau (square type): (Vcol, tc, ΔTc, Vcomp)

According to the state of the art, these parameters are a function of the temperature and the pixel size, but the parameters of the row-addressing signal VL are identical for all the pixels of the display and the parameters of the column-addressing signal VC can take as many values as desired texture states, but these values are identical for all the pixels of the display.

Using FIG. 2, it is possible to estimate that at a given temperature, during a two-step addressing, with a two-plateau row signal V1L and V2L during the second step: a reduction in absolute value of V2L promotes texture T and an increase in absolute value of V2L promotes texture U.

The pixel switching can be disrupted by certain defects such as for example, the distortion of the addressing signals due to the resistance of the electrodes, for example made of ITO

The Binem® switching in passive mode is sensitive to the electrical and geometrical features of the addressing band, which is not the case in active mode (see Document [7]). As described previously, a specificity of the Binem® is that the switching to texture T requires application to the pixel of an abrupt voltage drop in absolute value, called active trailing edge. This edge must, retain a sufficiently abrupt voltage drop in absolute value up to the extreme points (rows and columns) of the display, i.e. situated furthest away with respect to the start of the row- and column-addressing electrodes directly connected to the control circuits. The switching to texture U is also sensitive to the form of the pixel signal, and to the synchronization of the row-addressing signal with the column-addressing signal (Document [12]).

The behaviour of the band made of ITO is characterized by a time constant RC, constituted by the charge time of the pixel capacitance Cpx through the track and band resistances. This characteristic time will have a direct effect on the form of the signal, row and column, as shown in FIG. 6a for an example of a row-addressing signal, and 6b for an example of a column-addressing signal. The signals which are the least distorted, i.e. close to the start of the row-addressing electrode, are shown by unbroken lines, the signals affected by the constant RC, therefore more distant, are represented by dotted lines.

In FIG. 6a, the row-addressing signal is a two-plateau signal, the plateaux having levels V1L and V2L, the trailing edges of the two plateaux being called respectively FL1 and FL2. FL1d and FL2d designate the trailing edges of the addressing signal at the start of the row. FL1f and FL2f designate the trailing edges situated towards the “end” of the row. Due to the effect of the constant RC, it is noted that the trailing edges at the end of a row are distorted with respect to the trailing edges at the start of a row.

In FIG. 6b, the column signal is for example, single plateau, at Vcol level. The trailing edge called FCd designates the trailing edge of the column-addressing signal with the “start” of the column-addressing electrode directly connected to the control circuit, and FCf designates the trailing edge of the column-addressing signal situated towards the “end” of the column. Due to the effect of the constant RC, one can notice that the trailing edge towards the end of the column is deformed compared to the trailing edge towards the start of the column.

Document [7] describes quantitatively an example of a distortion of the end-of-row switching (see FIGS. 10a and 10b of this document). Document [7] demonstrates that the value of RC increases quadratically with the distance to the driver connection.

In FIGS. 6a and 6b it is noted that the time constant RC affects both the slope of the signal propagating on the electrode band (reduction of the slope in absolute value) and on the duration of the voltage plateau or plateaux (reduction of this duration). This double modification (slope, duration) is thus capable of creating switching heterogeneities in areas which are “too far” from the start of the electrode. Indeed, it is essential that the form of the voltage signal at the terminals of the last pixel should always be compatible with the desired switching. Accordingly, both the form of the row pulse and the form of the column pulse contribute to the form of the pixel signal and are therefore capable of affecting pixel switching to U or to T.

For the switching to T, one important parameter, among others, is the slope of the active trailing edge. For the switching to U, one important parameter, among others, is the synchronisation of the row-addressing signal with the column-addressing signal.

FIG. 7 clearly shows, by way of example, the different areas of the display capable of causing a problem. These are the areas situated at a certain distance from the start of the row- or column-addressing electrodes connected to the control circuit DRL for the rows and DRC for the columns, the effect increasing in relation to the distance with respect to the start of the row- or column-addressing electrodes. The area situated at the end of the row-addressing electrodes is defined as ZRCL and the area situated at the end of the column bands is defined as ZRCC. Any potential switching problems will possibly appear in these areas ZRCC and/or ZRCL. Of course the delimitation of these areas is not binary, any possible defect appearing progressively as the distance to the start of the electrodes increases. Moreover, the impact of a distortion on the switching will be different according to whether this distortion operates on the row-addressing signal or on the column-addressing signal.

FIG. 8 shows by way of illustration a Binem® QVGA type display of 56.6 mm (312 rows)×40.95 mm (234 columns) corresponding to a square pixel of 175 μm pitch. After a first step of collective change to texture T, this display was fully switched to texture U using a standard multiplexing signal (two-step addressing). In this example it is the column bands which are the longest, and in the ZRCC area, pixel-switching defects are noted, with the presence of texture T in the pixels which should be completely filled by textures U (so-called “T in U” defect). For example, in FIG. 8, it is noted that in the part at the bottom and to the right of the screen (part corresponding to the area common to the ZRCC and ZRCL areas in FIG. 7) the pixels are not fully changed to texture U (dark colour) and comprise textures T (light colour). For this experiment at ambient temperature, the parameters used are:

Two-Step Addressing, Black and White Type (No Grey Levels) with:

First step:

bi-polar square form pre-T signal of amplitude 25 V applied twice for 2 ms.

Second step: bipolar row signal, first polarity+25 V for 250 μs and second polarity: V1L=−25 V; V2L=−7 V; T1=250 μs; T2=120 μs; TL=50 μs

Vcol=4.5 V in order to obtain U structures and Vcol=0V in order to obtain T structures with tc=T2 and a constant RMS of Vrms=1.9 V.

Another potentially negative effect of the RC appears when an interlaced row addressing is used, i.e. when two adjacent rows are connected to two different drivers, the drivers being situated for example on either side of the display. The time constant RC then induces a desynchronization of the row signals of two adjacent rows at their end, this desynchronization causing switching defects.

Moreover, an RMS voltage stabilization difficulty is noted for the first rows of the display.

Document [8] describes the effect of the RMS voltage of the column-addressing signals on the switching and a method making its stabilization possible, in order to avoid switching defects. Use of this method poses a problem for the first rows of the display, corresponding to the area ZRMS in FIG. 7. In order to resolve this problem, a series of pre-pulses are applied, for example via the columns before display of the actual image, such that the first rows of the display also experience a constant RMS (see variant 4 and FIG. 19 of the document [8]). But it is noted that for rapid addressing conditions, a large number of pre-pulses must be applied, consequently extending the timeframe required for displaying an image. For a display as described in the previous paragraph, an increase of 25% in the timeframe was noted in order to obtain a correct switching of the first rows with a standard signal of the type described in the previous paragraph.

By way of illustration, FIG. 9 shows the display described in the previous paragraph, for which an insufficient number of pre-pulses, here around ten, was applied. It is sought to write an image with the signals as described in the previous paragraph. A T-switching defect is noted for the pixels which should normally be fully switched to T (light) situated on the first rows, corresponding to the ZRMS area of FIG. 7. A part of their surface is switched to U instead of T: a so-called “U in T” defect. At the end of the column electrodes, a switching defect of the pixels which should be fully switched to U (dark) is noted in the ZRCC area. A part of their surface is switched to T instead of U: a so-called “T in U” defect. Thus in this example, two types of defects are simultaneously present during the addressing of the display.

The subject of the invention is therefore to remedy these drawbacks.

### SUMMARY OF THE INVENTION

The invention therefore relates to a method for addressing a bistable nematic liquid crystal matrix screen having two stable states in the absence of an applied electrical field. This screen comprises two substrates with the liquid crystal arranged between them. The first substrate comprises row-addressing electrodes and the second substrate comprising column-addressing electrodes. Said addressing electrodes are in the form of electrically conductive bands. The switching of each pixel from one stable state to another is controlled by a switching electrical voltage pulse obtained by the application of at least one row-addressing signal applied to a first end of a row-addressing electrode and the application of at least one column-addressing signal applied to a first end of a column-addressing electrode.

According to the invention, the features of the row-addressing signals and/or the features of the column-addressing signals for the switching of a pixel of the matrix screen are a function of the position of said pixel in said matrix screen.

According to a preferred embodiment of the invention, the addressing of the pixels of said matrix screen is of the passive multiplexed type.

Advantageously, the row-addressing signal has at least one voltage plateau and that at least one of the following parameters of the row-addressing signal is a function of the position of each pixel in the matrix screen:
voltage level of said voltage plateau,
duration of said voltage plateau,
time separating two successive row-addressing signals.

It can also be provided that the row-addressing signal has at least two voltage plateaux and that at least one of the following parameters of the row-addressing signal is a function of the position of each pixel in the matrix screen:
voltage levels of the voltage plateaux,
duration of the voltage plateaux,
time separating two successive row-addressing signals.

As regards the column-addressing signal, the method according to the invention can provide that it comprises at least one voltage plateau and that at least one of the following parameters of the column-addressing signal is a function of the position of the pixel in the matrix screen:
voltage level of said voltage plateau of the column-addressing signal,
duration of said plateau of the column-addressing signal,
duration of desynchronization of the trailing edge of said voltage plateau of the column-addressing signal with respect to a trailing edge of a voltage plateau of a row-addressing signal.

Advantageously, the voltage level of the row-addressing signal is a function of the number of the row in the matrix screen.

The method according to the invention also provides that the row-addressing signal can comprise at least one upper plateau followed by a lower plateau in absolute value and that the voltage level of the lower plateau is a function of the number of the row in the matrix screen.

Moreover, it is also possible to provide for the features of the column-addressing signal of a pixel to be a function of the number of the column to which this pixel belongs.

In this case, advantageously, the features of the column-addressing signal of a pixel are a function of the number of the row to which this pixel belongs.

According to an embodiment variant, the row-addressing signal has the same features for all the rows of the matrix screen.

According to another embodiment variant, each column-addressing signal is applied to an end of the column-addressing electrodes and that the voltage level of the lower plateau of the row-addressing signal is increased in absolute value when the position of the addressed row addressing electrode is getting away from said ends of the column-addressing electrodes.

According to another embodiment variant according to the invention, prior to the display in multiplexed mode of each image to be displayed on the matrix screen by addressing of the row electrodes and the column electrodes, a signal is applied to all the pixels, conferring on them the same state, i.e. the same texture.

The method according to the invention also optionally provides that for modifying the display of one area only of the image of the matrix screen, a row-addressing signal is applied only to the row electrodes corresponding to said area.

According to a preferred embodiment according to the invention, the brushing direction of the anchoring layers is orthogonal to the direction of the row electrodes (L1 to LN) of the matrix screen.

Advantageously, the respective twists of the two stable textures of the liquid crystal differ by approximately 150° to 180° in absolute value.

The invention also provides that for modifying the display of one area of the image of the matrix screen only, a row-addressing signal is applied to the row electrodes corresponding to said area only.

Moreover, it can be provided that, prior to the display in multiplexed mode of each image or each image area to be displayed on the matrix screen by addressing the row electrodes and the column electrodes, a signal is applied to all the pixels of the image or said areas of the image, conferring on them the same state, i.e. the same texture.

Advantageously, the respective twists of the two stable textures of the liquid crystal differ by approximately 150° to 180° in absolute value.

The invention also relates to a method for addressing a liquid crystal matrix screen which provides that a second row-addressing signal is applied to a second end of said row-addressing electrode, and/or that a second column-addressing signal is applied to a second end of said column-addressing electrode.

Advantageously, the first and the second row-addressing signal have identical forms and/or the first and the second column-addressing signal have identical forms.

According to an advantageous embodiment of the invention, said two row-addressing signals are synchronized with each other and/or said two column-addressing signals are synchronized with each other.

According to another advantageous embodiment, said two row-addressing signals are the same signal and/or said two column-addressing signals are the same signal.

In order to control all the pixels of the matrix screen, a first and a second row-addressing signal and/or a first and a second column-addressing signal are applied respectively to each row-addressing electrode and/or to each column-addressing electrode.

Advantageously, the first row-addressing signals are identical to each other and are spaced apart by a fixed inter-row time (TL).

Advantageously, it will also be arranged for the row-addressing signals all to have identical forms and that the row-addressing signals have at least one trailing edge which is synchronized with at least one trailing edge of the column-addressing signals.

According to an embodiment of the invention, the row-addressing signals have a first plateau and at least one intermediate plateau and that at least one of the trailing edges of the column-addressing signals is synchronized with the trailing edge of said first plateau or with the trailing edge of said intermediate plateau of the row-addressing signals.

According to an embodiment variant, the row-addressing signals have a first plateau and at least one intermediate plateau and that at least one of the trailing edges of the column-addressing signals is desynchronized with the trailing edge of said first plateau or with the trailing edge of said intermediate plateau of the row-addressing signals.

According to another embodiment variant, the voltage level of the first plateau is greater in absolute value than the voltage level of the intermediate plateau.

According to another embodiment variant, the second end of each row-addressing electrode is intended to be connected either to a very high impedance or to a generator supplying a voltage equal to the voltage reached by one of the trailing edges of the row-addressing signal.

Advantageously, it will be arranged that each row-addressing signal applied to one of the ends of the row electrode has a value at least adequate, combined with the value of each column-addressing signal, to switch approximately half of the pixels of said row of the matrix screen situated on the side where the row-addressing signal is applied, no signal being applied at the other end.

The invention also provides for a variant in which the method comprises at least three steps:
a first step of addressing the rows situated on the side of the first ends of the column electrodes, during which first column-addressing signals are applied to these first ends, no signal being applied to the second ends of the column electrodes,
a second step of addressing the rows situated in the central part of the rows of the matrix screen during which first column-addressing signals are applied to the first ends of the column-addressing electrodes and second column-addressing signals are applied to the second ends of the column-addressing electrodes,
a third step of addressing the rows situated on the side of the second ends of the column-addressing electrodes during which second column-addressing signals are applied to these second ends, no signal being applied to the first ends of the column electrodes.

The invention also relates to a display device as described previously and in which a control circuit makes it possible to control the features of said row-addressing signal and/or the features of said column-addressing signal as a function of the position of a pixel to be controlled in the matrix screen.

Advantageously, the addressing of the pixels of said matrix screen is of the passive multiplexed type.

According to an embodiment of the device of the invention, the row-addressing signal has at least two different voltage plateaux, and the control circuit controls at least one of the following parameters of the row-addressing signal as a function of the position of each pixel in the matrix screen:
voltage levels of the voltage plateaux,
duration of the voltage plateaux,
time separating two successive row-addressing signals.

According to an embodiment variant, the control circuit controls at least one of the following parameters of the column-addressing signal as a function of the position of the pixel in the matrix screen:
voltage levels of the column-addressing signal,
duration of the column-addressing signal,
duration of the desynchronization of the trailing edge of said voltage plateau of the column-addressing signal with respect to a trailing edge of a voltage plateau of a row-addressing signal.

Advantageously, the voltage level of at least one plateau of the row-addressing signal is a function of the position of the row in the matrix screen.

According to another embodiment variant, the row-addressing signal comprises at least one upper plateau followed by a lower plateau and that the central control circuit controls the voltage level of the lower plateau as a function of the position of the row in the matrix screen.

According to another embodiment variant the features of the column-addressing signal of a pixel are a function of the number of the column of said pixel, while the row-addressing signal has the same features for all the rows of the matrix screen.

The invention also relates to a bistable liquid crystal display device having two stable states in the absence of an electric field comprising at least two row control circuits each connectable to one end of a row-addressing electrode and thus making it possible to apply two row-addressing signals to the two ends of the row-addressing electrodes and/or two column control circuits each connectable to one end of each column-addressing electrode and making it possible to apply at least two column-addressing signals to the two ends of the column-addressing electrodes.

Advantageously, the two row-control circuits making it possible to address a single row-addressing electrode are a single circuit having two outputs for each row electrode, and/or in that the two column-control circuits making it possible to address a single column-addressing electrode are a single circuit having two outputs for each column.

### BRIEF DESCRIPTION OF THE FIGURES

The various objects and characteristics of the invention will become more clearly apparent in the following description and in the attached figures in which:

FIG. 1 shows a diagrammatic representation of the bistable display of BiNem type,

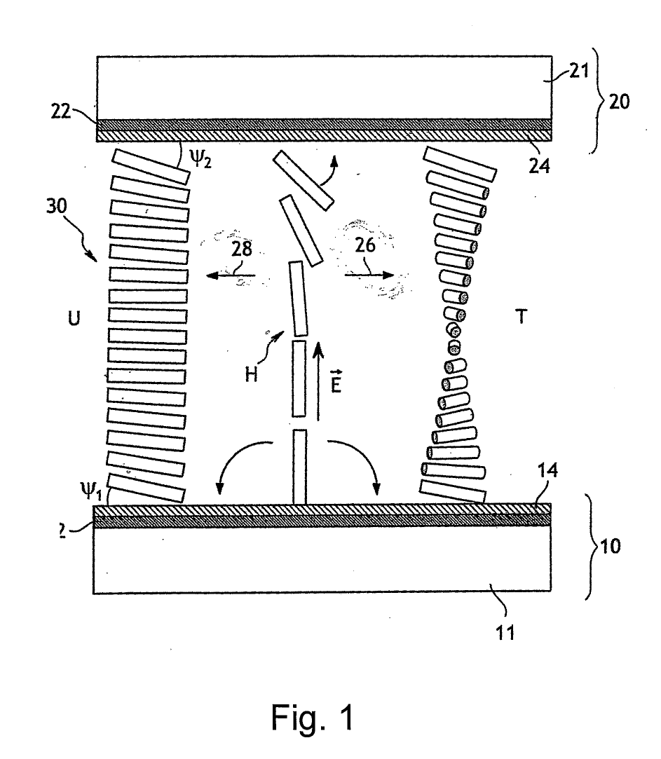

FIG. 2 describes an example of two-plateau pixel addressing signal with voltage levels (V1P, V2P) and the active trailing edge of this signal as a function of the voltage level of the plateau V2P,

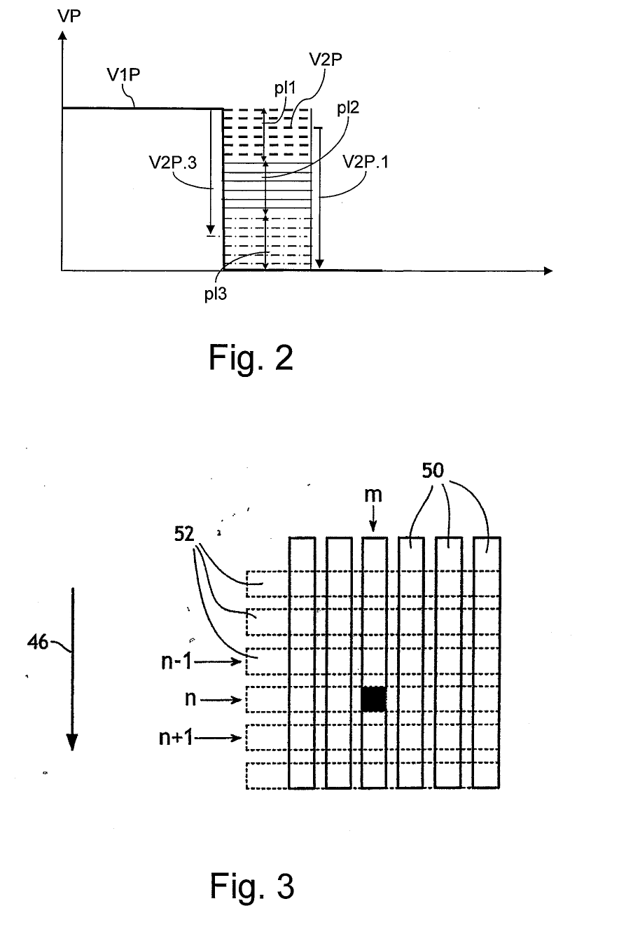

FIG. 3 describes the structure of a multiplexed passive-addressing liquid crystal matrix screen,

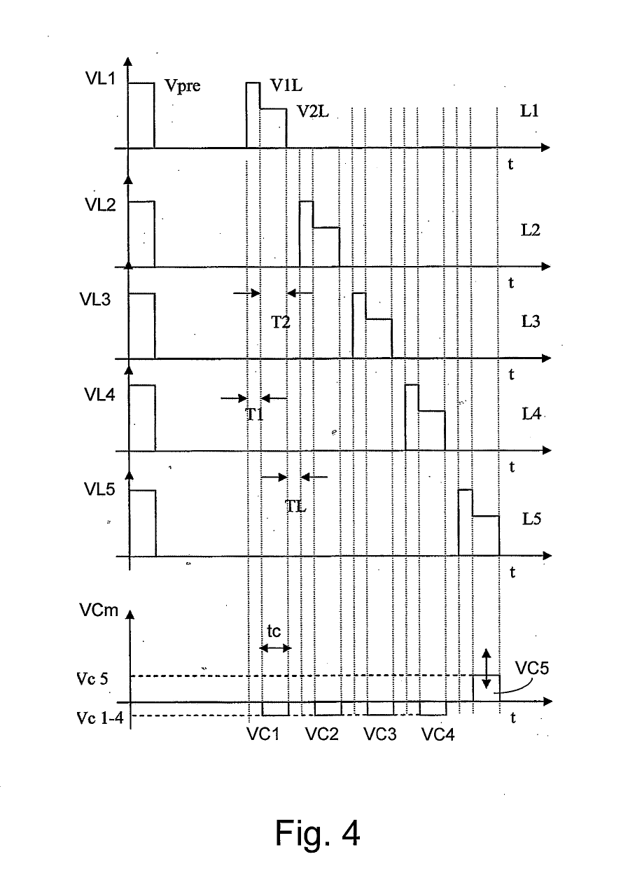

FIG. 4 describes an example of two-step addressing of a passive screen of BiNem type,

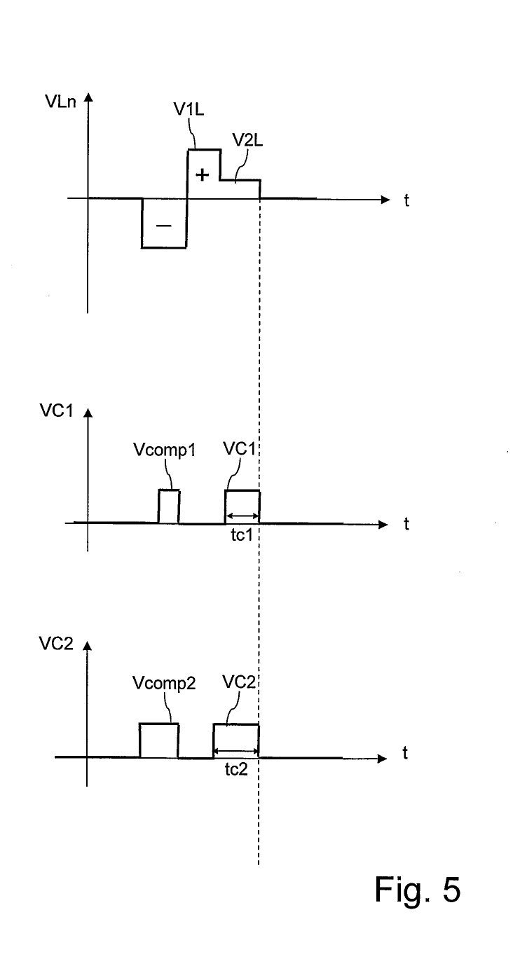

FIG. 5 describes a chronogram of the application of the method making it possible to obtain a predetermined constant mean squared voltage,

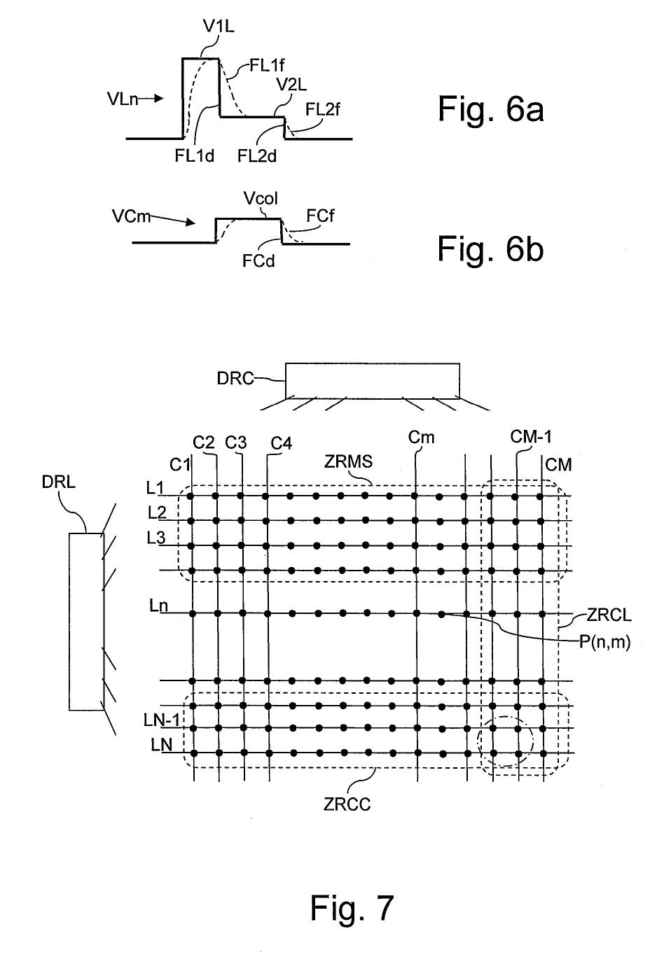

FIGS. 6a and 6b describe an example of measurement of a two-plateau row-addressing signal at a location very close to the connection with the control circuit and at a location distanced from this connection,

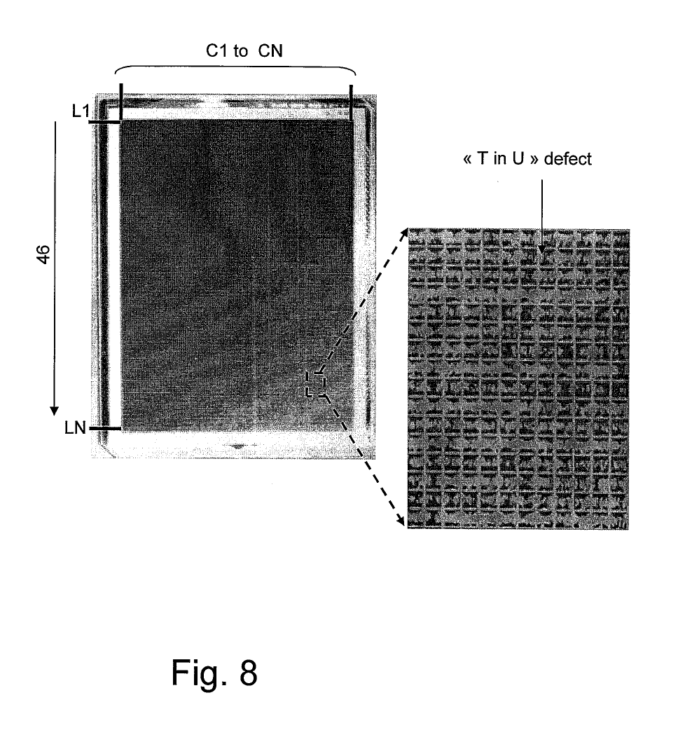

FIG. 7 describes diagrammatically a display of the matrix screen type as well as the different areas of this screen capable of being distorted, in terms of switching, by the effect of the time constant RC.

FIG. 8 represents a screen having display defects in an area distant from the ends of the row- and column-electrodes to which addressing signals are applied,

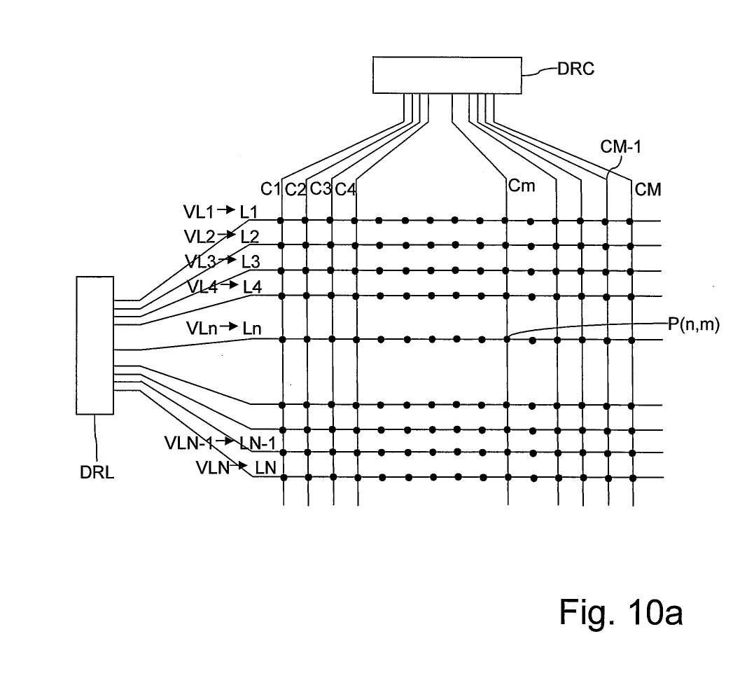

FIG. 9 represents photographs of a screen also having display defects,

FIGS. 10a and 10b, illustrate examples of embodiments of the method according to the invention,

FIGS. 10c and 10d show diagrammatically variations according to the invention in voltage levels of a row-addressing signal,

FIG. 11 represents photographs of a screen which, according to the invention, does not have display defects,

FIG. 12 represents control circuits of a matrix screen according to the invention,

FIG. 13 describe different variants of the invention. FIG. 13a describes a variant where the invention is applied to a row of the display. FIG. 13b describes a variant where the invention is applied to all the rows of the display. FIG. 13c describes a variant where the invention is applied to all the columns of the display. FIG. 13d describes a variant where the invention is applied to all the rows and to all the columns of the display,

FIG. 14 describe a variant of the invention which uses control circuits. FIG. 14a describes a variant of the invention where the row-addressing electrodes are connected at each of their ends to a control circuit. FIG. 14b describes a variant of the invention where the column-addressing electrodes are connected at each of their ends to a control circuit,

FIG. 15 describes a variant of the invention where the two ends of the row-addressing electrodes are connected to a single control circuit.

### DETAILED DESCRIPTION

In order to resolve the problems and defects of switching described above, and also other defects which can appear on displays of BiNem® type, the invention consists of applying a pixel signal VP, defined by all the pixel-addressing parameters, which, for a given temperature range and pixel form, depends on the spatial position in the display of the pixel in question. A pixel P is referenced with respect to the number n of its row (n from 1 to N, for example in the direction of the sweep), and m for its column (m from 1 to M). The pixel signal VP applied to the pixel P(n,m) becomes, according to the invention, a function of its position in the display VP (n,m).

In a multiplexed addressing, the pixel voltage VP is the difference between the voltage applied to its row when it is activated, and its column: VP=VL−VC. According to the invention the pixel voltage VP becomes a function of n and/or m, i.e. the row signal becomes a function of n, VL(n), and/or the column signal becomes a function of m, VC(m) and optionally of the row VC(m,n).

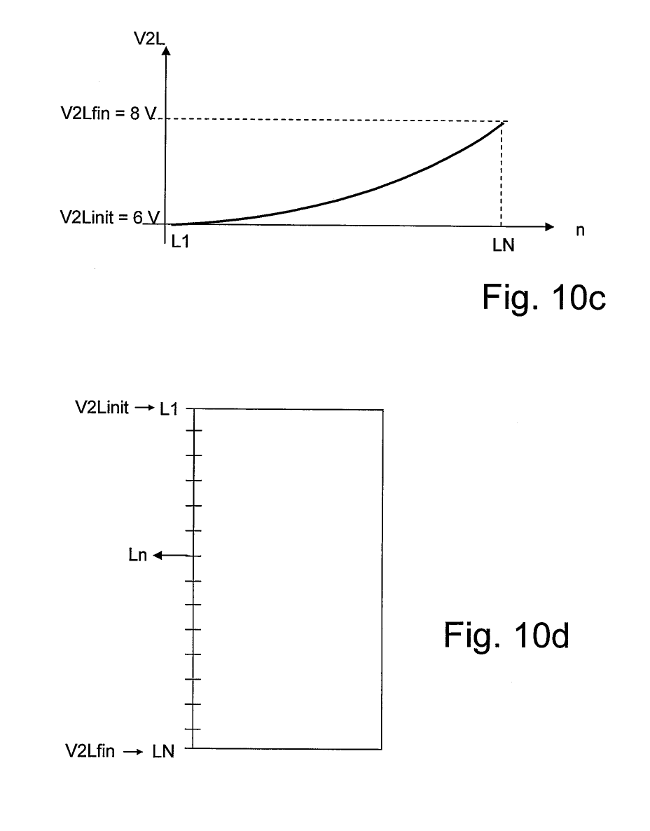

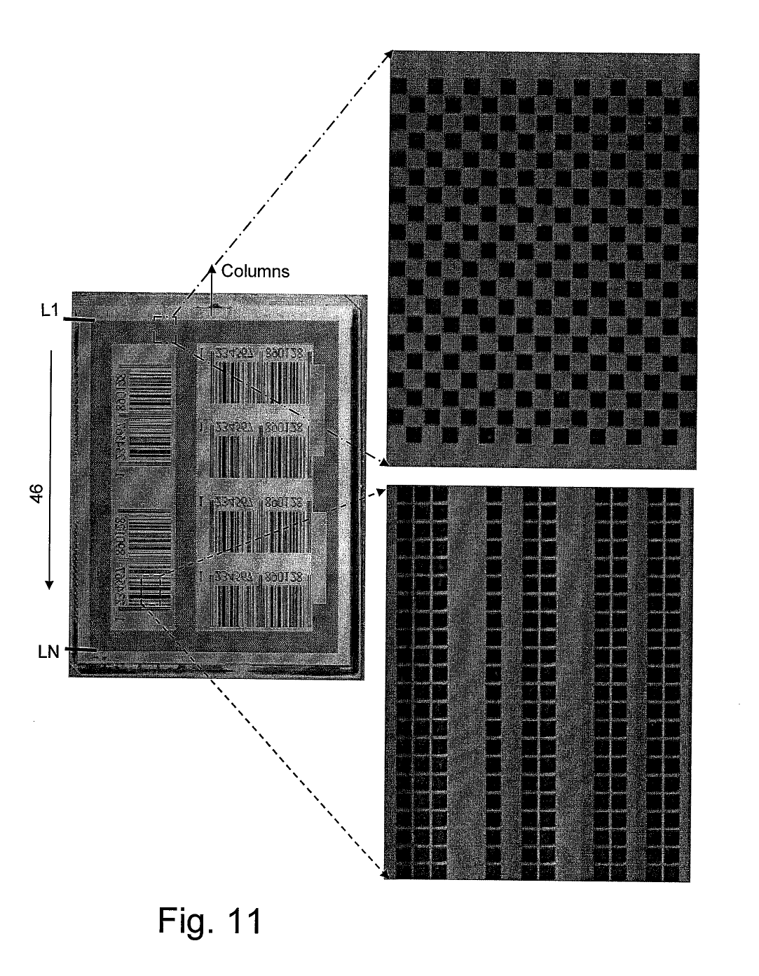

According to a first variant shown in FIG. 10a, the row-addressing signal VL becomes a function of n, VL(n), n being the number of the row and the column-addressing signal VC is independent of m. It depends only on the texture that it is desired to obtain. According to this variant, at least one parameter of the row-addressing signal is variable as a function of the row n.

Thus we have: VP(n)=VL(n)−VC, with VC independent of m.

According to a second variant shown in FIG. 10b, the column-addressing signal VC becomes a function of m, number of the column, and optionally of n, with the row-addressing signal VL remaining independent of n. According to this variant, at least one parameter of the column signal is variable as a function of the column m and optionally the row n.

Thus we have:

VP(m)=VL−VC(m)

or VP(n,m)=VL−VC(n,m)

with VL independent of n.

In the general case, the first and second variant are combined, and at least one parameter of the row-addressing signal is a function of n while at least one parameter of the column-addressing signal is a function of m and optionally n for addressing a pixel P(n,m).

Thus we have:

VP(n,m)=VL(n)−VC(m)

or VP(n,m)=VL(n)−VC(n,m).

The variation of at least one parameter of the row-addressing signal and/or the column-addressing signal can be defined for example, according to a first non-limitative option, by a function (linear, polynomial or other) of n and/or m.

According to a second option, the variation of at least one parameter of the row-addressing signal and/or the column-addressing signal can be defined for example by ranges. A group of adjacent rows or columns then have a constant value of this/these parameters, this constant may be for example, but non-limitatively, defined by a function.

The parameters on which the invention can be applied are, non-limitatively:
parameters of the row-addressing signal VL:
voltage level of each plateau of the row-addressing signal VL, for example in the case of a row-addressing signal comprising two plateaux V1L, V2L
duration of these plateaux (T1, T2 for these two plateaux),
and inter-row time TL
parameters of the column-addressing signal VC:
voltage level of each plateau of the column-addressing signal,
duration of these plateaux,
desynchronization value of a trailing edge of a plateau of the column-addressing signal with a trailing edge of a plateau of the row-addressing signal ΔTc, value of Vcomp

For example in the case of a column-addressing signal comprising a single plateau (square type): (Vcol, tc, ΔTc, Vcomp)

Of course it is possible to choose different forms for the row- and columns-addressing signals, for example single-plateau, two-plateau or multi-plateau, each plateau being characterized by a voltage level and a duration. Different forms of signals, not necessarily constituted by plateaux, can also be considered.

For example, in order to correct the switching defects mentioned previously, identified in ZRCL appearing at the ends or at the “finish” of all the rows, the invention is applied by compensating for this problem of homogeneity by a variation of the column signal VCm. For example Vcol, or tc, ΔTc, Vcomp is modified as a function of m. The advantage of using a variation of synchronization ΔTc has the benefit of not introducing a spatial variation of the RMS voltage.

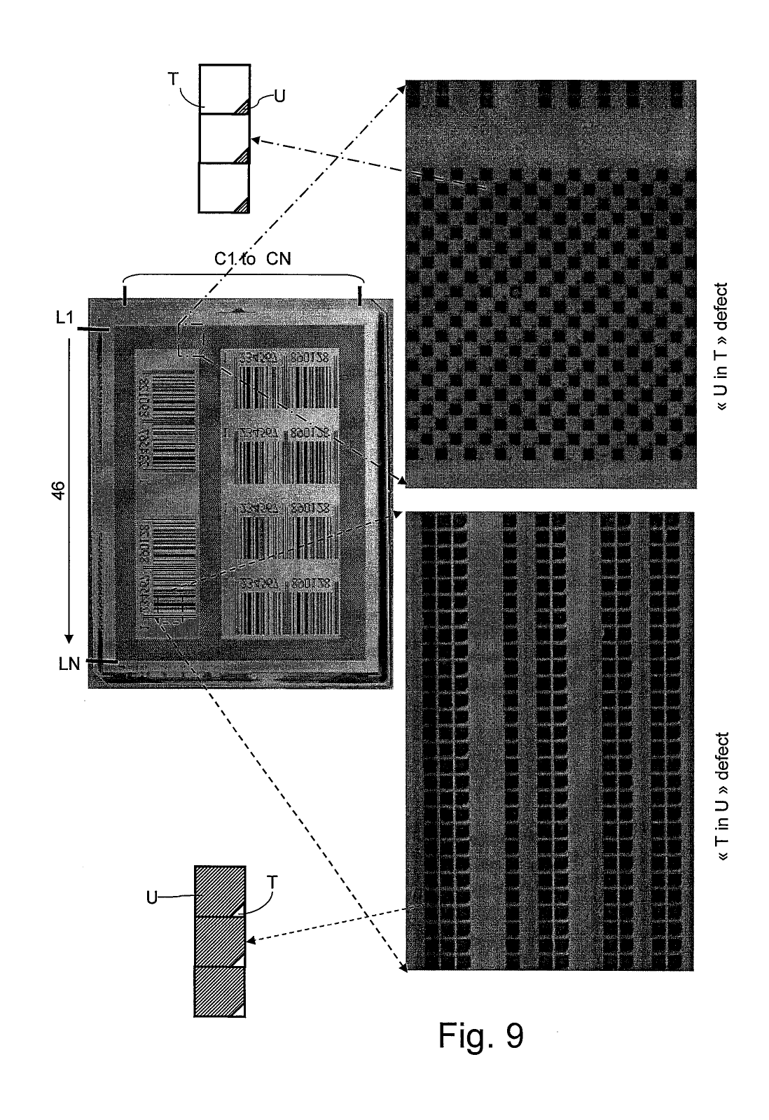

For example, in order to correct the switching defects mentioned previously identified in ZRCC appearing at the ends or at the “finish” of all the columns, defects of the “T in U” type, the invention is applied by compensating for this problem of homogeneity by a variation of the row signal VL(n), so as to promote the switching to U for the rows corresponding to the ends of the columns, i.e., for example, for the rows of the area ZRCC of FIG. 7.

For example, in order to correct the switching defects mentioned previously identified in ZRMS appearing for the first rows in the direction of sweep, defects of the “U in T” type, the invention is applied by compensating for this problem of homogeneity by a variation of the row signal VL(n), so as to promote switching to T for the first rows.

Thus by an appropriate variation of the row-addressing signal as a function of n, the invention makes it possible to correct simultaneously the defects previously described and present in ZRMS and ZRCC.

According to the invention, it is noted that at a given temperature, during an addressing with a row-addressing signal with two plateaux V1L and V2L, a reduction in absolute value of V2L promotes texture T and an increase in absolute value of V2L promotes texture U, which will make it possible for this double correction to be obtained. Implementation of the invention in this case consists of varying the amplitude of V2L as a function of n, with a somewhat lower value of V2L for the first rows (promoting the switching to T) and a somewhat higher value of V2L for the last rows (promoting the switching to U).

An example of implementation is described by FIGS. 10c and 10d for the display described previously. The voltage of the second plateau V2L takes the value V2Linit for the row L1 and V2Lfin for the last row LN. In FIG. 10a, V2Linit and V2Lfin respectively have the values 6V and 8V. The intermediate values of V2L for the other rows are calculated with a quadratic-type law:

V2L(n)=V2Linit+a(n−1)²

V2Linit(n=1)=6V

V2Lfin(n=N=312)=8V

The other parameters, which are fixed (at a given temperature, here 25° C.), i.e. not as a function of n are:

First step:

bipolar square form pre-T signal of amplitude 25 V applied twice for 2 ms.

Second step:

bipolar row signal, first polarity+25 V for 250 μs

and second polarity:
V1L=−25 V; T1=250 μs; T2=120 μs; TL=50 μs

Vcol=4.5 V for texture U and Vc=0V for texture T, etc.

Tc=T2 Vrms=1.9 V

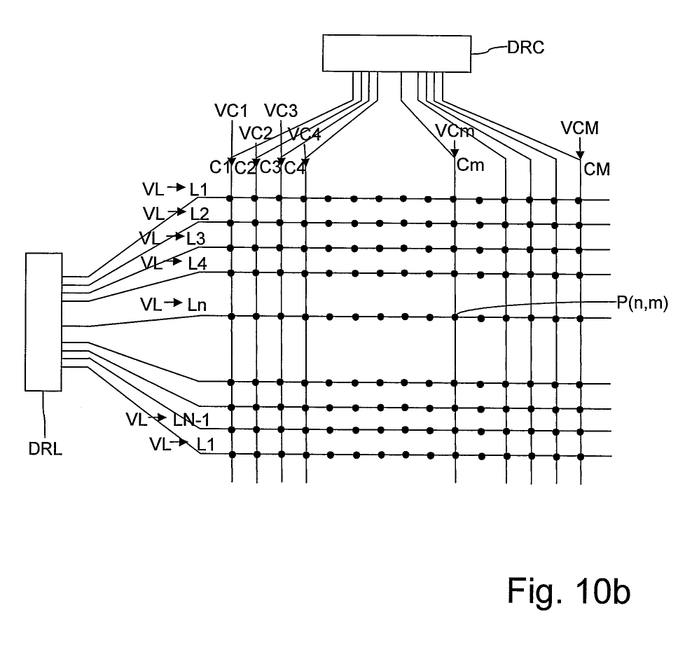

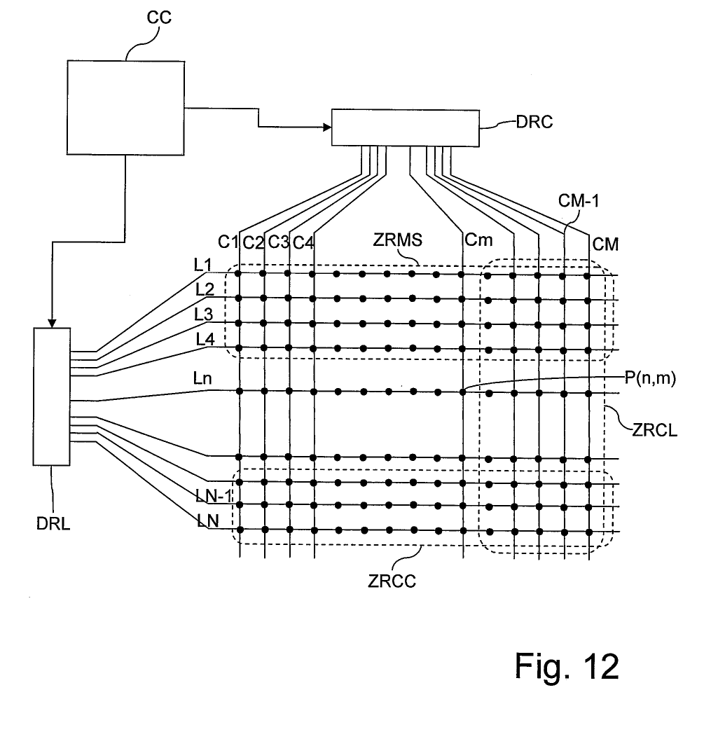

FIG. 11 shows an image displayed with this method. The zooms on the ZRMS and ZRCC areas show the disappearance of the previous defects described in FIG. 9.

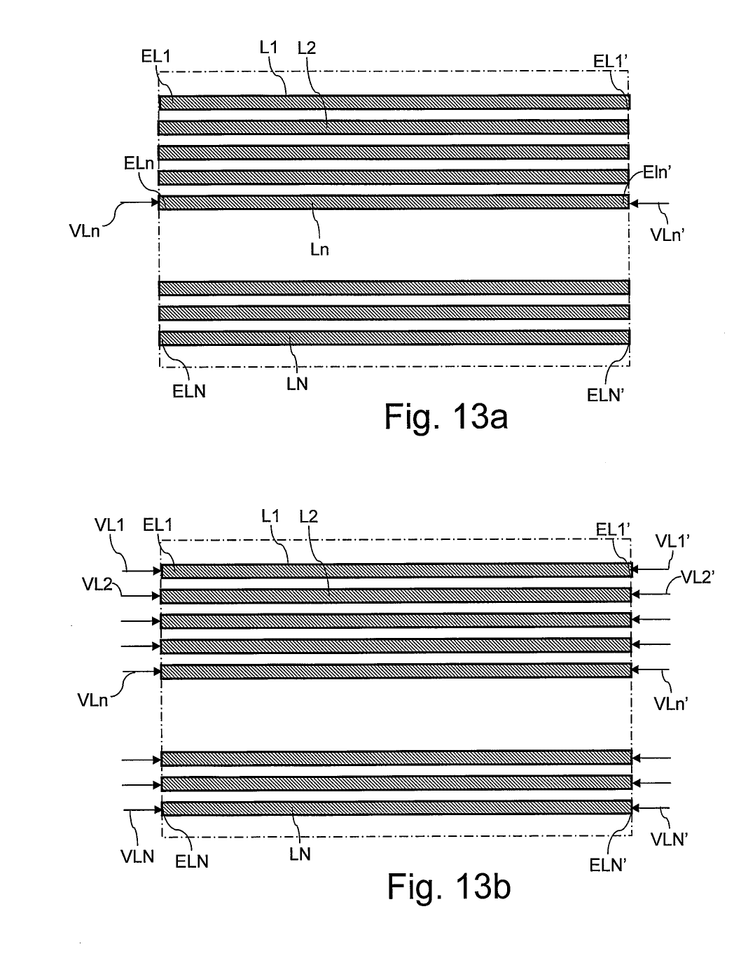

FIG. 12 represents a matrix screen such as that of FIG. 7 with its circuit for addressing the row electrodes DRL and its column-addressing circuit DRC. Furthermore, a central control circuit CC makes it possible to control the addressing circuits for driving the addressing of the rows and columns and for controlling the features of the row- and column-addressing signals as a function of the positions of the rows and columns, as it has just been described.

The present invention is of course applicable in order to obtain homogeneous grey levels over all of the display.

The invention also relates to an addressing method for a liquid crystal display addressed in passive-type multiplexed mode, where a row-addressing signal and a column signal are applied to one of the ends of the row- and of column-addressing electrodes. In this method according to the invention, addressing signals are also applied to the other end of said row- and/or column-addressing electrodes. This principle of the method will be described in more detail in the description which follows.

According to a preferred, but non-limitative, embodiment, the addressing is carried out using control circuits of the “driver” type.

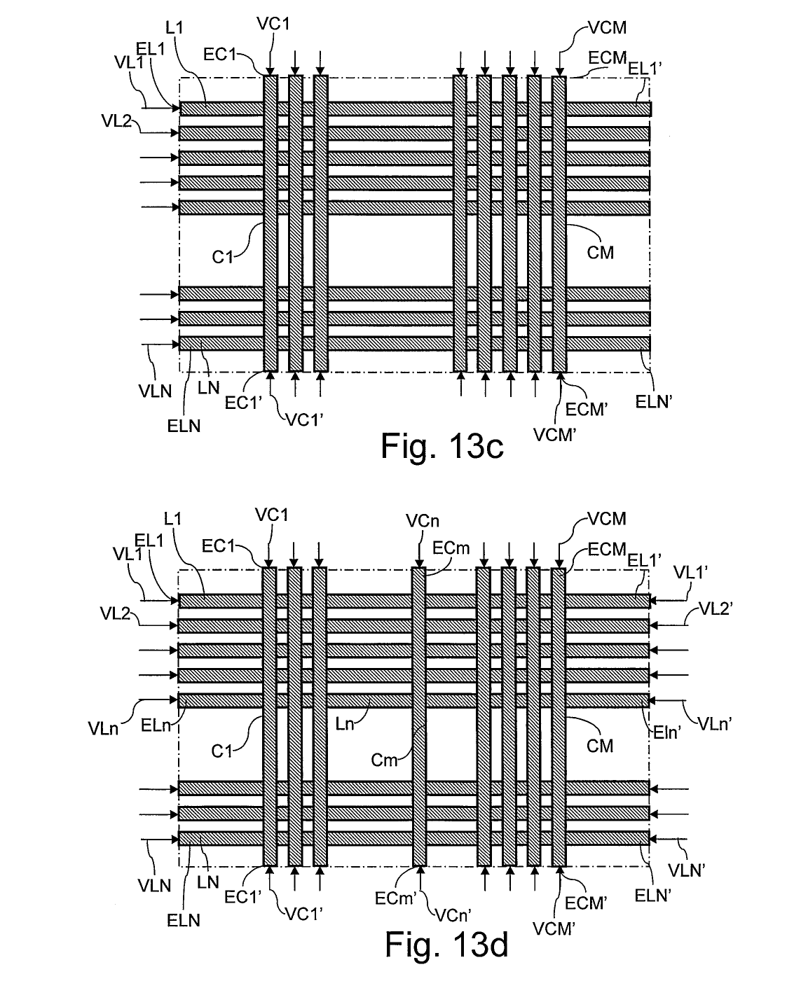

According to a variant, at least one row-addressing electrode is addressed according to the invention. FIG. 13a describes a matrix screen including a row-addressing electrode Ln, the row and the row electrode being grouped under the same name L, comprising a first end ELn by which a first row-addressing signal VLn is applied and a second end ELn′ by which a second row-addressing signal VLn′ is applied.

According to a variant all the row-addressing electrodes of the display are addressed according to the invention. FIG. 13b describes a matrix screen each of the electrodes of rows L1 to LN of which is addressed by a first row-addressing signal VL1 to VLN via a first end EL1 to ELN and by a second row-addressing signal VL1′ to VLN′ via a second end ELi′ to ELN′. For example the column-addressing electrodes are addressed according to the state of the art, via a single end.

According to a variant, at least one column-addressing electrode is addressed according to the invention.

According to another variant, all the column-addressing electrodes of the display are addressed according to the invention. FIG. 13c describes a matrix screen each of the electrodes of column C1 to CM of which is addressed by a first column-addressing signal VC1 to VCM via a first end EC1 to ECM and by a second column-addressing signal VC1′ to VCM′ via a second end EC1′ to ECM′. The rows L1 to LN are addressed with a row-electrode signal VL1 to VLN via a single end EL1 to ELN.

It is also possible to combine a variant of the invention applied to the rows with a variant of the invention applied to the columns. FIG. 13d describes such a combination which combines an addressing according to the invention of all the rows and of all the columns.

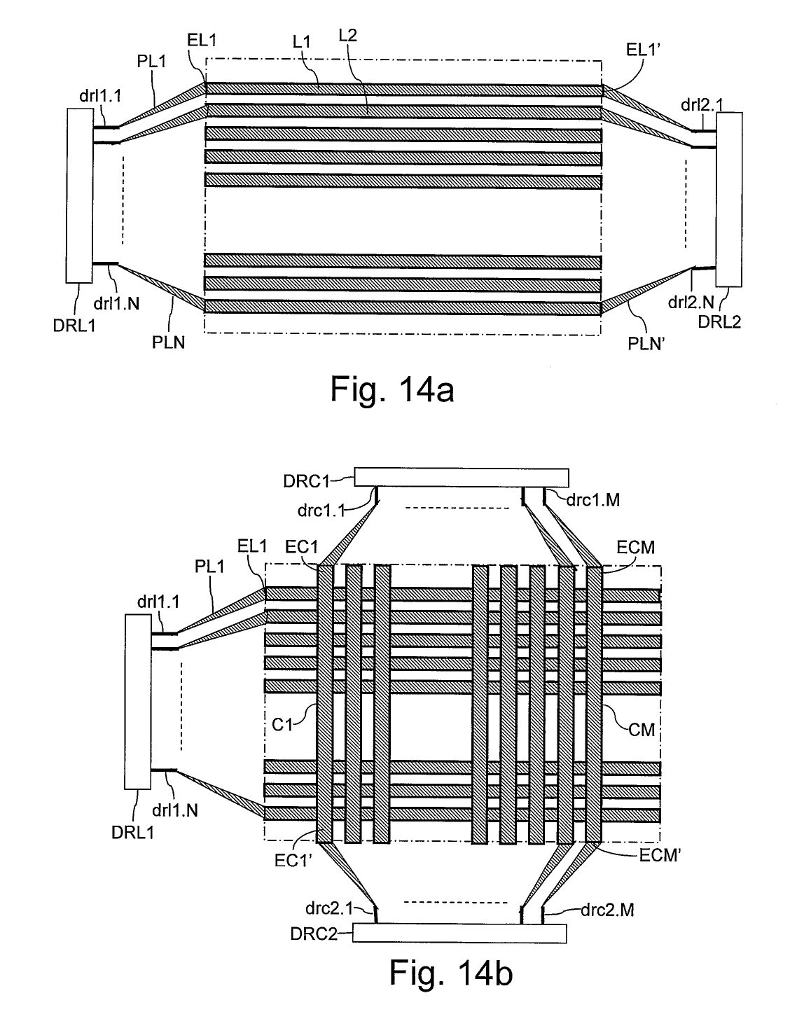

According to a variant, the row- and/or column-addressing signal is obtained by at least one control circuit connected to the ends of the row- and/or column-addressing electrodes via connection tracks. FIG. 14a describes the connection of all the rows L1 to LN to a control circuit DRL1, from outputs drl1.1 to drl1.N, to the first ends EL1 to ELN via the tracks PL1 to PLN and to a control circuit DRL2, from outputs drl2.1 to drl2.N, to the second ends EL1′ to ELN′ via the tracks PL1′ to PLN′.

FIG. 14b describes the connection of all the columns C1 to CM to a control circuit DRC1 from outputs drc1.1 to drc1.M to the first ends EC1 to ECM and to a control circuit DRC2 from outputs drc2.1 to drc2.M to the second ends EC1′ to ECM′, while the rows L1 to LN are connected in a standard fashion to a control circuit DRL1 via the outputs drl1.1 to drl1.N to the first ends EL1 to ELN only.

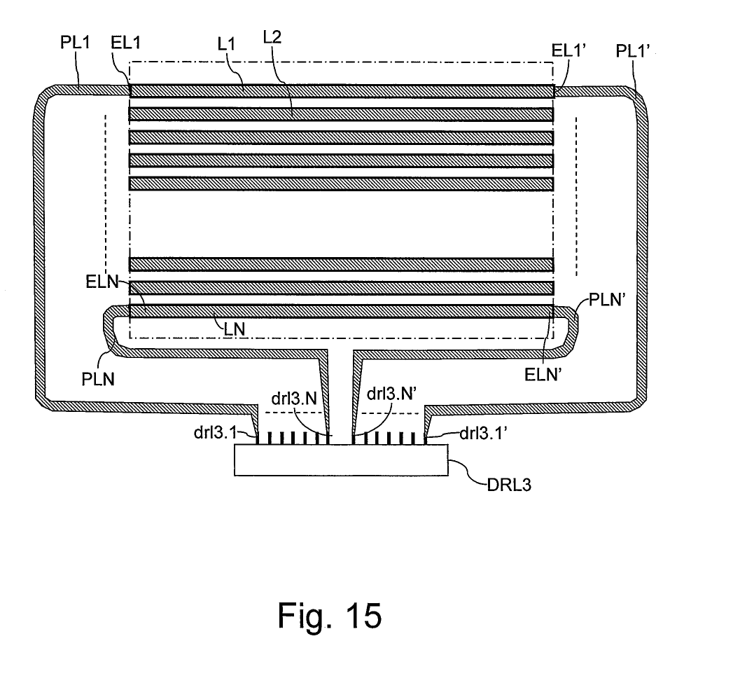

According to another variant, the two ends of a single row-addressing electrode and/or of a single column-addressing electrode are connected via the tracks to a single control circuit. FIG. 15 describes the connection of the first ends EL1 to ELN via the tracks PL1 to PLN and of the second ends EL1′ to ELN′ via the tracks PL1′ to PLN′ to a single control circuit DRL3 comprising two outputs for each row drl3.1 to drl3.N and drl3.1′ to drl3.N′.

According to another variant, the addressing signals according to the invention applied to the two ends are synchronized.

According to another variant, the addressing signals applied to the two ends are of identical forms.

According to another variant, the addressing signals applied to the two ends are a single signal supplied by a common control circuit such as the control circuit DRL3 of FIG. 15.

A variant suited to improving the discharge only, is to apply a standard addressing signal via a control circuit to one end of the band, and a binary signal to the other end via a switch-type component, collectively for all the bands: either a very high impedance to maintain the applied voltage, or a low-impedance connection to the voltage level that it is desired to obtain at the end of the discharge. The discharge is thus accelerated by using a simpler component than a driver component used for the addressing of passive displays.

The invention is compatible with the addressing of an area of the screen only, in which it is desired to display a new content, the rest of the image remaining identical (partial addressing).

The invention is compatible with two-step addressing, a first collective step intended to make all the pixels change to the same state, i.e. one single texture, then a second step where the addressing is carried out according to the standard multiplexed mode. Advantageously, the signal applied according to the invention to the second end of the electrodes is also applied during the first step.

The invention is compatible with obtaining grey levels as described in the state of the art.

According to the state of the art, the activation signal of the rows V1L to VNL is identical for all the rows, equal to VL.

According to an advantageous embodiment of the invention, the same addressing signal as a function of the position of the pixel in the matrix screen is applied to the two ends of the row- and/or column-addressing electrodes.

The invention is also applicable to a bistable display of the active type comprising a transistor per pixel as described for example in the document [7]. In this type of display, the row signal serves only to “open” the transistor, therefore in this case the invention consists of spatially modulating the column signal only.

The present invention moreover comprises other advantages.

A first advantage is the possibility, due to the possible correction of the RC effect, of using Binem® type bistable technology to produce large-size displays (A5, A4 format or larger).

Three other advantages result from the possible correction of the RC effect by implementation of the invention. Firstly, a less conductive ITO (i.e. more resistive), which is therefore thinner and therefore more economic can be used for the electrodes of the display. Secondly, a more capacitive liquid crystal, i.e. with a higher [symbol] , resulting in a greater sensitivity of the liquid crystal to the electric field, can be used in the cell. Thirdly, it can be envisaged that the thickness of the liquid crystal cell of the display be reduced, with implementation of the invention being able to compensate for the resulting increase in the pixel capacitance.

Another advantage is that the correction of the defects mentioned previously increases the possibilities of control of the display, i.e. the optimization range of the drive parameters. Another advantage is the increase in the refresh rate, since according to the state of the art, without using the invention, a timeframe increase was necessary to reduce or remove certain switching defects.

### DOCUMENTS CITED

Document [1]: U.S. Pat. No. 6,327,017
Document [2]: I. Dozov et al, “Recent improvements of bistable nematic displays switched by anchoring breaking (BiNem)”, Proceeding SID 2001, p 224-227
Document [3]: P. Martinot Lagarde et al SPIE vol. 5003 (2003), p 25-34
Document [4]: M. Giocondo, I. Lelidis, I. Dozov, G. Durand, Eur. Phys. J. AP5, 227 (1999)
Document [5]: I. Dozov, Ph. Martinot-Lagarde, Phys. Rev. E., 58, 7442 (1998).
Document [6]: FR 2835 644
Document [7]: US 2006-0022919
Document [8]: PCT/FR2007/050965
Document [9]: WO 2004/104980
Document [10]: WO 2005/054940
Document [11]: WO 2005/054941
Document [12]: FR 0753626

1. A method for addressing a bistable nematic liquid crystal matrix screen having two stable states in the absence of an applied electric field, the screen including two substrates between which the liquid crystal is disposed, the first substrate comprising row-addressing electrodes and the second substrate comprising column-addressing electrodes, said addressing electrodes being presented in the form of electrically conductive bands, comprising: the switching of each pixel from a stable state to another stable state, being controlled by a switching electrical voltage pulse obtained by the application of at least one row-addressing signal applied to a first end of a row-addressing electrode and the application of at least one column-addressing signal applied to a first end of a column-addressing electrode, the features of the row-addressing signals and/or the features of the column-addressing signals for the switching of a pixel of the matrix screen are a function of the position of said pixel in said matrix screen.

2. The method according to claim 1, characterized in that the addressing of the pixels of said matrix screen is of passive multiplexed type.

3. The method according to claim 2, characterized in that the row-addressing signal has at least one voltage plateau and in that at least one of the following parameters of the row-addressing signal is a function of the position of each pixel in the matrix screen:
voltage level of said voltage plateau,
duration of said voltage plateau,
time separating two successive row-addressing signals.

4. The method according to claim 3, characterized in that the row-addressing signal has at least two voltage plateaux and in that at least one of the following parameters of the row-addressing signal is a function of the position of each pixel in the matrix screen:
voltage levels of the voltage plateaux,
duration of the voltage plateaux,
time separating two successive row-addressing signals.

5. The method according to claim 2, characterized in that the column-addressing signal has at least one voltage plateau and in that at least one of the following parameters of the column-addressing signal is a function of the position of the pixel in the matrix screen:
voltage level of said voltage plateau of the column-addressing signal,
duration (tc) of said plateau of the column-addressing signal,
duration of desynchronization (ΔTC) of the trailing edge of said voltage plateau of the column-addressing signal with respect to a trailing edge of a voltage plateau of a row-addressing signal.

6. The method according to claim 3, characterized in that the voltage level of at least one voltage plateau of the row-addressing signal is a function of the number of the row in the matrix screen.

7. The method according to claim 4, characterized in that the row-addressing signal comprises at least one upper plateau followed by a lower plateau in absolute value and in that the voltage level of the lower plateau is a function of the number of the row in the matrix screen.

8. The method according to claim 1, characterized in that the features of the column-addressing signal of a pixel are a function of the number of the column to which said pixel belongs.

9. The method according to claim 8, characterized in that the features of the column-addressing signal of a pixel are a function of the number of the row to which said pixel belongs.

10. The method according to claim 8, characterized in that the row-addressing signal has the same features for all the rows of the matrix screen.

11. The method according to claim 7, characterized in that each column-addressing signal is applied to an end of the column-addressing electrodes and in that the voltage level of the lower plateau of the row-addressing signal is increased in absolute value when the position of the addressed row addressing electrode is getting away from said ends of the column-addressing electrodes.

12. The method according to claim 1, characterized in that prior to the display in multiplexed mode of each image to be displayed on the matrix screen by addressing the row electrodes and the column electrodes, a signal is applied to all the pixels, conferring on them the same state, i.e. the same texture.

13. The method according to claim 1, characterized in that to modify the display of only an area of the image of the matrix screen, a row-addressing signal is applied only to the electrodes of rows corresponding to said area.

14. The method according to claim 1, characterized in that the brushing direction of the anchoring layers is orthogonal to the direction of the row electrodes of the matrix screen.

15. The method according to claim 1, characterized in that the respective twists of the two stable textures of the liquid crystal differ by approximately 150° to 180° in absolute value.

16. The method according to claim 1, characterized in that said method provides that a second row-addressing signal, is applied to a second end of said row-addressing electrode, and/or that a second column-addressing signal is applied to a second end of said column-addressing electrode.

17. The method according to claim 16, characterized in that the first and the second row-addressing signal are of identical forms and/or the first and the second column-addressing signal are of identical forms.

18. The method according to claim 16, characterized in that the two said row-addressing signals are synchronized with each other and/or the two said column-addressing signals are synchronized with each other.

19. The method according to claim 18, characterized in that the two said row-addressing signals are a single signal and/or the two said column-addressing signals are a single signal.

20. The method according to claim 18, characterized in that in order to control all the pixels of the matrix screen, a first and a second row-addressing signal and/or a first and a second column-addressing signal are applied respectively to each row-addressing electrode and/or to each column-addressing electrode.

21. The method according to claim 20, characterized in that the first row-addressing signals are identical to each other and are spaced apart by a fixed inter-row time.

22. The method according to claim 1, characterized in that the row-addressing signals have a first plateau and at least one intermediate plateau and in that at least one of the trailing edges of the column-addressing signals is synchronized with the trailing edge of said first plateau or with the trailing edge of said intermediate plateau of the row-addressing signals.

23. The method according to claim 16, characterized in that the row-addressing signals have a first plateau and at least one intermediate plateau and in that at least one of the trailing edges of the column-addressing signals is desynchronized with respect to the trailing edge of said first plateau or with respect to the trailing edge of said intermediate plateau of the row-addressing signals.

24. The method according to claim 22, characterized in that the voltage level of the first plateau (V1L) is greater in absolute value than the voltage level of the intermediate plateau (V2L).

25. The method according to claim 16, characterized in that the second end of each row-addressing electrode is intended to be connected either to a very high impedance or to a generator supplying a voltage equal to the voltage reached by one of the trailing edges of the row-addressing signal.

26. The method according to claim 16, characterized in that each row-addressing signal applied to one of the ends of the row electrode has a value at least adequate, combined with the value of each column-addressing signal, to switch approximately half of the pixels of said row of the matrix screen situated on the side where the row-addressing signal is applied, no signal being applied at the other end.

27. The method according to claim 16, characterized in that the method comprises at least three steps:
a first step of addressing the rows situated at the side of the first ends of the column electrodes during which first column-addressing signals are applied to these first ends, no signal being applied to the second ends of the column electrodes,
a second step of addressing of the rows situated in the central part of the rows of the matrix screen during which first column-addressing signals are applied to the first ends of the column-addressing electrodes and second column-addressing signals are applied to the second ends of the column-addressing electrodes,
a third step of addressing the rows situated at the side of the second ends of the column-addressing electrodes during which second column-addressing signals are applied to these second ends, no signal being applied to the first ends of the column electrodes.

28. A display device applying the method according to claim 1 comprising: a bistable nematic liquid crystal matrix screen having two stable states in the absence of an applied electric field, said screen comprising two substrates between which is disposed the liquid crystal, the first substrate comprising row-addressing electrodes and the second substrate comprising column-addressing electrodes, the row-addressing electrodes being addressed one-by-one while all the column-addressing electrodes are addressed simultaneously for the activation time of each row, the switching of each pixel from a stable state to another stable state, being controlled by a switching electrical voltage pulse obtained by the application of at least one first row-addressing signal applied to a row-addressing electrode and the application of at least one column-addressing signal applied to a column-addressing electrode, including a control circuit making it possible to control the features of said row-addressing signal and/or the features of said column-addressing signal as a function of the position of a pixel to be controlled in the matrix screen.

29. The device according to claim 28, characterized in that the addressing of the pixels of said matrix screen is of passive multiplexed type.

30. The device according to claim 29, characterized in that the row-addressing signal has at least two different voltage plateaux and in that the control circuit controls at least one of the following parameters of the row-addressing signal as a function of the position of each pixel in the matrix screen:
voltage levels of the voltage plateaux,
duration of the voltage plateaux,
time separating two successive row-addressing signals.

31. The device according to claim 28, characterized in that the column-addressing signal comprises at least one plateau and in that the control circuit controls at least one of the following parameters of the column-addressing signal as a function of the position of the pixel in the matrix screen:
voltage levels of said plateau of the column-addressing signal,
duration (tc) of said plateau of the column-addressing signal,
duration of desynchronization (ΔTC) of the trailing edge of said voltage plateau of the column-addressing signal with respect to a trailing edge of a voltage plateau of a row-addressing signal.

32. The device according to claim 30, characterized in that the voltage level of at least one plateau of the row-addressing signal is a function of the position of the row in the matrix screen.

33. The device according to claim 32, characterized in that the row-addressing signal comprises at least one upper plateau followed by a lower plateau in absolute value and in that the central control circuit controls the voltage level of the lower plateau as a function of the number of the row in the matrix screen.

34. The device according to claim 28, characterized in that the features of the column-addressing signal of a pixel are a function of the number of the column of said pixel, while the row-addressing signal has the same features for all the rows of the matrix screen.

35. The device according to claim 28, further including at least two row control circuits each of which can be connected to an end of a row-addressing electrode and thus making it possible to apply two row-addressing signals to the two ends of the row-addressing electrodes and/or two column control circuits each of which can be connected to an end of each column-addressing electrode and making it possible to apply at least two column-addressing signals to the two ends of the column-addressing electrodes.
